(19) United States
(12) Patent Application Publication
(10) Pub. No.: US 2005/0198245 A1
(43) Pub. Date: Sep. 8, 2005

(54) Intelligent modular remote server management system

(76) Inventors: John Burgess, Pittstown, NJ (US); Tzu-Chiang Wang, Taipei (TW)

Correspondence Address: Ward & Olivo, 708 Third Avenue, New York, NY, 10017, US

(21) Appl. No.: 10/794,811

(22) Filed: Mar. 6, 2004

(51) Int. Cl. G06F 15/173

(52) U.S. Cl. 709/223

(57) ABSTRACT

Disclosed is a remote network management system for coupling a series of remote devices, such as servers, network appliances, serial IT equipment, switches, routers, firewalls, security interfaces, application servers, load balancers, environmental controls, etc., to one or more user workstations allowing for selective access and control of the remote devices. The remote devices are all connected to a remote management unit which interfaces each user workstation to the remote devices. The power supply of each remote device is similarly connected to the remote management unit through a controllable power supply. An option menu containing a list of all of the remote devices allows a user to select and operate any of the remote devices from the remote workstation. An option menu displayable on the workstation monitor is also utilized for the user to selectively control the power to the remote devices, servers, and computers.

### FIELD OF THE INVENTION

The present invention relates to a computer management system for remotely controlling computers and servers from one or more local user workstations through a remote control device. Specifically, a keyboard, video monitor, and/or cursor control device attached to a computer are utilized to access the remote control device via any network connection. In turn, the remote control device is coupled to the remote computers and servers through computer interface modules obviating the need for any additional software to be installed on the remote computers.

### BACKGROUND OF THE INVENTION

In many situations, it is desirable to manage networking equipment, servers, and computers located at a location remote from the system administrator. If the distance is great enough, the Internet is commonly utilized to control computers from a remote location. For example, a software program such as pcAnywhere may be utilized to access a remote computer over the Internet or a LAN utilizing the keyboard, video monitor, and cursor control device attached to a local user workstation. Remote computer access programs, such as pcAnywhere, typically require that host software is installed on the remote computer and client software is installed on the user workstation. To access a remote computer, a user of the user workstation selects the desired remote computer from a list and enters the appropriate username and password. Once access has been granted to the remote computer, the user utilizes the keyboard, video monitor, and cursor control device attached to the local user workstation to access and operate the remote computer.

Hardware solutions also exist for operating a remote computer from a user workstation over the Internet or via a modem. In contrast to software solutions, hardware solutions do not typically require host and/or client software. Instead, hardware solutions typically utilize a keyboard, video monitor, and mouse (“KVM”) switch which is accessible over the Internet or LAN via a common protocol, such as TCP/IP. The hardware solutions may also utilize a modem to connect to the Internet. Generally, a user or system administrator accesses the remote computers attached to the KVM switch utilizing an Internet web-browser or client software associated with the KVM switch. Once the remote computer has been selected, the remote computer's video signal is routed to the user workstation's video monitor and a user may then utilize a keyboard and/or mouse to control the remote computer. The KVM switch may additionally include a connection to the power source of the remote computer for a hard reboot in case of system failure.

The aforementioned hardware and software solutions generally utilize compression algorithms to reduce the necessary bandwidth required to transmit the video signals. For example, the remote network management system of the present invention may use the compression algorithm disclosed in application Ser. No. 10/233,299, which is incorporated herein by reference, to reduce and compress the digital data that must be transmitted to the remote computers and/or video display devices. Generally, video signals generated by a personal computer have both spatial and interframe redundancies. For example, in a near idle personal computer, the only change between successive frames of video might be the blinking of a cursor. Even as a user types a document, a majority of the screen does not change over a period of time. Hence, the compression algorithm used by the present invention takes advantage of these redundancies, both between successive frames of video and within each individual frame, to reduce the amount of digital video signal data that is transmitted to the remote computers and/or video display devices. Reducing the amount of digital data transmitted over the communication medium decreases communication time and decreases the required bandwidth.

Most forms of video compression known in the art require complicated calculations. For example, Moving Pictures Experts Group (“MPEG”) video compression algorithms use the discrete cosine transform as part of its algorithm. Also, the MPEG standard relies on the recognition of “motion” between frames, which requires calculation of motion vectors that describe how portions of the video image have changed over a period of time. Since these algorithms are calculation intensive, they either require expensive hardware or extended transmission times that allow sufficient time for slower hardware to complete the calculations.

In addition to complexity, many existing video compression techniques are lossy (i.e., they do not transmit all of the video signal information in order to reduce the required bandwidth). Typically, such lossy techniques either reduce the detail of a video image or reduce the number of colors utilized. Although reducing the number of colors could be part of an adequate compression solution for some computer management systems applications, in many other applications, such a result defeats the intended purposes of the computer management system.

Many systems related to remote management of computers and servers are known in the art of computer management. For example, one such system includes an apparatus for coupling a local user workstation, including a keyboard, mouse, and/or video monitor, to a remote computer. In this system, a remote computer is selected from a menu displayed on a standard size personal computer video monitor. Upon selection of a remote computer by the system user, the remote computer's video signals are transmitted to the local user workstation's video monitor. The system user may also control the remote computer utilizing the local user workstation's keyboard and monitor. The system is also capable of bi-directionally transmitting mouse and keyboard signals between the local user workstation and the remote computer. The remote computer and the local user workstation may be connected either via the Public Switched Telephone System (“PSTN”) and modems or via direct cabling.

A similar known system is a specific implementation of a computerized switching system for coupling a local keyboard, mouse and/or video monitor to one of a plurality of remote computers. In particular, a first signal conditioning unit includes an on-screen programming circuit that displays a list of connected remote computers on the local video monitor. To activate the menu, a user depresses, for example, the “print screen” key on the local keyboard. The user selects the desired computer from the list using the local keyboard and/or mouse.

In this system, the on-screen programming circuit requires at least two sets of tri-state buffers, a single on-screen processor, an internal synchronization generator, a synchronization switch, a synchronization polarizer, and overlay control logic. The first set of tri-state buffers couples the red, green, and blue components of the video signals received from the remote computer to the video monitor. That is, when the first set of tri-state buffers are energized, the red, green, and blue video signals are passed from the remote computer to the local video monitor through the tri-state buffers. When the first set of tri-state buffers are not active, the video signals from the remote computer are blocked. Similarly, the second set of tri-state buffers couples the outputs of the single on-screen processor to the video monitor. When the second set of tri-state buffers is energized, the video output of the on-screen programming circuit is displayed on the local video monitor. When the second set of tri-state buffers is not active, the video output from the on-screen programming circuit is blocked. Alternatively, if both sets of tri-state buffers are energized, the remote computer video signals are combined with (i.e., overlaid onto) the video signals generated by the on-screen programming circuit prior to display on the local video monitor.

During operation of the system, a remote computer is chosen from the overlaid video display. Thereafter, the first signal conditioning unit receives keyboard and mouse signals from the local keyboard and mouse and generates a data packet for transmission to a central cross point switch. The cross point switch routes the data packet to the second signal conditioning unit, which is coupled to the selected remote computer. The second signal conditioning unit then routes the keyboard and mouse command signals to the keyboard and mouse connectors of the remote computer. Similarly, video signals produced by the remote computer are routed from the remote computer through the second signal conditioning unit, the cross point switch, and the first signal conditioning unit to the local video monitor. The horizontal and vertical synchronization video signals received from the remote computer are encoded on one of the red, green or blue video signals. This encoding reduces the quantity of cables required to transmit the video signals from the remote computer to the local video monitor.

Another known system includes a KVM switching system capable of coupling to a standard network (e.g., a Local Area Network) operating with a standard network protocol (e.g., Ethernet, TCP/IP, etc.). The system couples a central switch to a plurality of computers and at least one user station having a keyboard, video monitor, and mouse. The central switch includes a network interface card (“NIC”) for connecting the central switch to a network, which may include a number of additional computers or remote terminals. Utilizing this system, a user located at a remote terminal attached to the network may control any of the computers coupled to the central switch.

Finally, yet another known system includes a keyboard, video, mouse, and power switching (“KVMP”) apparatus for connecting a plurality of computers to one or more user stations having an attached keyboard, video monitor, and mouse. On screen display (“OSD”) circuitry embedded within the KVMP switching apparatus allows a user located at a user station to select and operate any one of the computers utilizing the keyboard, video monitor, and mouse attached to the user station. Secondary switching circuitry located within the KVMP switching apparatus allows a user located at a user station to additionally control the electrical power supplied to each computer.

In view of the foregoing, a need exists for an improved remote computer management system capable of allowing users to remotely operate computers and servers through a remote control switching unit where a user is enabled to select and control any one of a number of remote computers or servers from a remote location via a network connection such as a local area network (LAN), a wide area network (WAN), a wireless local area network (WLAN), an Internet connection, etc.

### SUMMARY OF THE INVENTION

The present invention provides a remote network management system for administrating a remote computer networking environment from one or more local user workstations with attached peripheral devices (i.e., keyboard, video monitor, cursor control device, etc.). The remote network management system of the present invention allows a user located at a user workstation to access, operate, and control networking equipment, servers, and computers located at a remote location.

In the preferred embodiment of the present invention, each remote device (e.g, server, computer, etc.) is directly connected to a computer interface module (CIM). All CIMs connect to a central matrix switching unit (MSU), which is connected to one or more networks (WANs, LANS, etc.), and/or the Internet to allow users to access the remote devices. In the preferred embodiment, users access the MSU through a web-browser, or equivalent, implemented on a standard computer, laptop, palmtop, etc. The user is presented with a graphical user interface (GUI) from which the user can select a remote device from among the plurality of available remote devices to monitor and/or control. The user controls the selected remote device with the user's local keyboard and mouse, while receiving video from the remote device, which is displayed on the local monitor.

The MSU additionally contains a port for connection to a power supply capable of controlling the power to the networking equipment, servers, and computers. Standard cabling is utilized to connect the remote computers to the CIMs and each of the CIMs to the central MSU.

The MSU also provides compatibility between various operating systems and/or communication protocols, including but not limited to, those manufactured by Microsoft Corporation (“Microsoft”) (Windows), Apple Computer, Inc. (“Apple”) (Macintosh), Sun Microsystems, Inc. (“Sun”) (Solaris), Digital Equipment Corporation (“DEC”), Compaq Computer Corporation (“Compaq”) (Alpha), International Business Machines (“IBM”) (RS/6000), Hewlett-Packard Company (“HP”) (HP9000) and SGI (formerly “Silicon Graphics, Inc.”) (IRIX).

To utilize the remote network management system of the present invention, a user first initiates a management session by utilizing client software located on a user workstation to connect to the MSU. Alternatively, the user may utilize a web-browser (e.g., Internet Explorer, Netscape Navigator, etc.) to connect to the MSU. The user is then prompted by the MSU to provide a user name and a password. The MSU is capable of storing multiple profiles and different levels of access for each profile. Once a user has been authenticated, the user is provided an option menu on the user workstation. The option menu preferably consists of a menu listing all the servers, and computers at the remote location. The option menu additionally contains a menu allowing a user to control the power to each piece of remote equipment. The user selects the desired server, or computer by utilizing the keyboard and/or cursor control device attached to the user workstation. Once a user makes a selection, the user is provided access to the remote equipment as if the user is physically located at the remote site.

The MSU and the user workstation preferably communicate via TCP/IP. The remote server or computer outputs video to a standard video output port, which is connected to a CIM. The CIM, in turn, connects to the MSU. Thus, the MSU receives analog video from the remote computer. However, since the MSU and the user workstation communicate via TCP/IP, the analog video signals must first be digitized and compressed. In the preferred embodiment, the compression algorithm described herein and in co-pending application Ser. No. 10/233,299 which is hereby incorporated by reference in its entirety, is used to transmit the video signals. However, the video transmission system is not limited to such an embodiment.

Similarly, the system of the present invention allows for bi-directional communication of keyboard and cursor control device data between the local user's computer and the select remote device. Again, the communication between the local user's workstation and the MSU is accomplished with TCP/IP data. Therefore, similar to the transmission of video data, the MSU must create TCP/IP data packets with data indicative of keyboard and mouse signals when transmitting data from the select remote computer to the local user workstation. Conversely, the MSU must interpret TCP/IP data to emulate keyboard and mouse signals when transmitting data from the local user to the remote device.

Since the present invention can be used to display video signals at locations that may be at a great distance from the MSU, it is important to ensure that the video signal transmission is secure. If the transmission is not secure, hackers, competitors, or other unauthorized users could potentially view confidential information contained within the video signals. Therefore, the remote network management system of the present invention is designed to easily integrate with digital encryption techniques known in the art. In one embodiment of the present invention, a 128-bit encryption technique is used both to verify the identity of the MSU and to encrypt and decrypt the transmitted video and data signals. In this embodiment, a 128-bit public key RSA encryption technique is used to verify the remote participant, and a 128-bit RC4 private key encryption is used to encrypt and decrypt the transmitted signals. Of course, other encryption techniques or security measures may be used.

Finally, the MSU also includes other accessibility options including local administrator access whereby a user can perform administrative functions from a keyboard, monitor and mouse connected directly to the MSU using standard cabling. Such administrative functions may include adding or changing user IDs and passwords, upgrading the firmware or software on the MSU, monitoring overall system usage, etc. The video displayed to the administrator may be generated by a general purpose CPU within the MSU. Alternatively, a standard on-screen display (“OSD”) processor may be utilized to generate an option menu and interface for the administrator.

As an additional means of access, the MSU also preferably includes a modem to allow a user workstation to access remote computers through a telephone line connection. Although this connection generally provides less bandwidth than a network connection, it can be used as a backup or emergency means of accessing remote computers (e.g., if there is a network failure).

Therefore, it is an object of the present invention to provide an improved, remote network management system that enables a user to control any one of a plurality of remote devices from any one of a plurality of local user workstations through any network or Internet connection.

Further, it is an object of the present invention to provide a remote network management system that allows one or more local user workstations to access and operate remote servers, and computers connected to a remote management unit through a computer interface module.

It is another object of the present invention to provide a single, platform-independent remote network management system offering centralized, integrated, and secure control.

It is an additional object of the present invention to provide a network-independent remote network management system containing a modem for emergency access.

It is a further object of the present invention to provide a remote network management system capable of providing direct access to the keyboard, mouse and video ports of a remote device over a network connection.

Additionally, it is an object of the present invention to provide a remote network management system which provides a single consolidated view of all servers and other connected devices from one screen via a web browser.

It is another object of the present invention to provide a remote network management system which first requires a user to provide a valid user identification and password.

Additionally, it is an object of the present invention to provide a remote network management system which is upgradeable.

It is a further object of the present invention to provide a remote network management system which provides high performance over low bandwidth connections including modem, wireless, cable, DSL, and fractional T1.

It is another object of the present invention to provide a remote network management system which utilizes a video compression algorithm and frame-grabber technology to ensure efficient transmission of high quality video.

It is still a further object of the present invention to provide a remote network management system that is easy to install and operate.

In addition, it is an object of the present invention to provide a remote network management system that is compact and provides readily accessible communications ports.

It is also an object of the present invention to provide a remote network management system capable of controlling the power supply to remotely located networking equipment, servers, and computers.

Other objects, features, and characteristics of the present invention, as well as the methods of operation and functions of the related elements of the structure, and the combination of parts and economies of manufacture, will become more apparent upon consideration of the following detailed description with reference to the accompanying drawings, all of which form a part of this specification.

### BRIEF DESCRIPTION OF THE DRAWINGS

A further understanding of the present invention can be obtained by reference to a preferred embodiment set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference is now made to the following drawings in which:

FIG. 1 is a schematic representation of a remote network management system according to the preferred embodiment of the present invention illustrating the connection of a plurality of user workstations that include, for example, a keyboard, video monitor and cursor control device to a plurality of remote computers.

FIG. 2 is a screen-shot of a sample option menu utilized to control the networking equipment, servers and computers in a system according to the invention.

FIG. 3A is a block diagram showing the internal components of the preferred embodiment of the MSU shown in FIG. 1.

FIG. 3B shows a schematic representation of the internal layout of the MSU shown in FIG. 1.

FIG. 3C shows an example layout of the connectors on the back panel of the MSU shown in FIG. 1.

FIG. 4A is a detailed block diagram of the switching and control module shown in FIG. 3A.

FIG. 4B is a detailed block diagram of the switching and control module shown in FIG. 4A further depicting the interconnection of the components thereof.

FIG. 5A is a block diagram of the video compression module shown in FIG. 3A, which implements the video compression algorithm of the preferred embodiment of the present invention.

FIG. 5B is a more detailed block diagram of the video compression module shown in FIG. 5A.

FIG. 6 is a schematic representation of the preferred embodiment of the computer interface modules (“CIMs”) shown in FIG. 1 illustrating the internal structure of the CIM including circuitry utilized for the management features of the present invention.

### DETAILED DESCRIPTION OF THE PREFERRED EMBODIMENTS

As required, a detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention. The following presents a detailed description of the preferred embodiment (as well as some alternative embodiments) of the present invention.

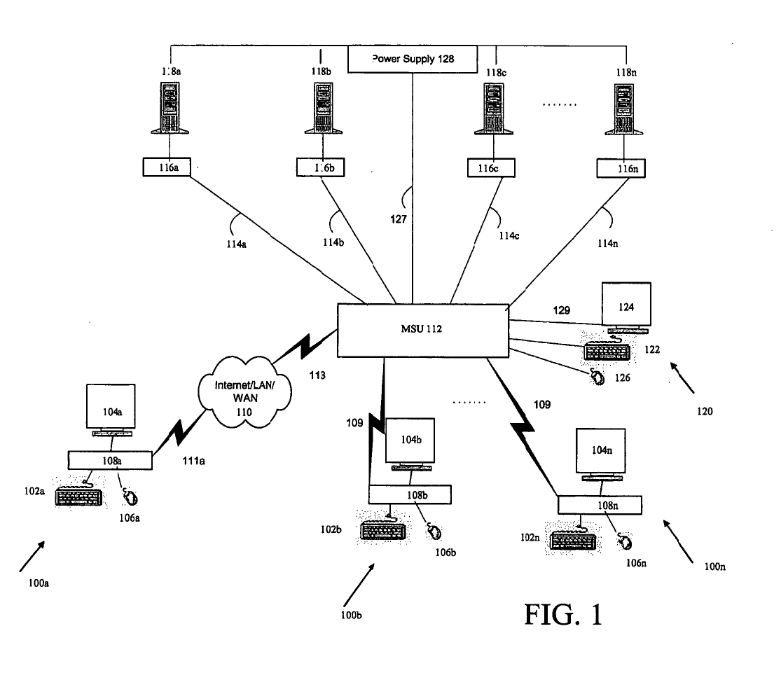

Referring first to FIG. 1, depicted is the architecture of the preferred embodiment of a remote network management system in accordance with the present invention. Specifically, a remote network management system is shown comprising users workstation 100a-n, each including a corresponding keyboard 102, video monitor 104, and cursor control device 106. Preferably, each usero workstation 100 comprises a general purpose computer 108, such as a laptop, desktop, palmtop, etc. Software (which may be loaded within a web-browser) is loaded on computer 108 and thus enables a user to access MSU 112 and remote computers 116 according to the present invention. Other peripheral devices may also be located at each user workstation 100, such as a printer, scanner, video camera, biometric scanning device, microphone, etc. Each peripheral device is directly or indirectly connected to user workstation 100. Of course, wireless peripheral devices may also be used with this system.

Also included in the system of the present invention is matrix switching unit (“MSU”) 112, Internet/LAN/WAN 110, remote computers 118a-n, power supply 128, computer interface modules (“CIMs”) 116a-n, and local user workstation 120, which includes local keyboard 122, local video monitor 124 and local cursor control device 126. MSU 112 is preferably connected to Internet 110 through connection 113, thus allowing any user workstation 100 to access MSU 112 through an Internet connection 111 to Internet 110. Alternatively, MSU 112 can also be accessed through a local area network (LAN), wide area network (WAN), etc. For example, as shown in FIG. 1, a user workstation 100 can also access MSU 112 through network connection 109.

Although CAT 5 cabling is the preferred cabling for communication lines 111 and 113, other cabling may be used such as coaxial, fiber optic or multiple CAT 5 cables. CAT cabling is preferred because it reduces cabling cost while maintaining the strength of signals that are transmitted over an extended distance. Alternatively, wireless networking may also be utilized to connect MSU 112 to Internet/LAN/WAN 110, CIMs 116, and power supply 128.

In a preferred mode of operation, all electronic signals (i.e., keyboard signals and cursor control device signals) received at user workstation 100 from attached peripheral devices are transmitted to MSU 112, either through Internet/LAN/WAN 110 via communication line 111. Thereafter, the signals are transmitted to MSU 112 via communication line 113. Alternatively, the signals may be transmitted directly from user workstation 100 to MSU 112 via communication line 109 which represents a dedicated leased line connection. MSU 112 transmits the received signals to a select remote computer 118 through the corresponding CIMs 116.

MSU 112 may be compatible with all commonly used, present day computer operating systems and protocols, including, but not limited to, those manufactured by Microsoft (Windows), Apple (Macintosh), Sun (Unix), DEC, Compaq (Alpha), IBM (RS/6000), HP (HP9000) and SGI. Additionally, local devices may communicate with remote computers via a variety of protocols including Universal Serial Bus (“USB”), American Standard Code for Information Interchange (“ASCII”) and Recommend Standard-232 (“RS-232”).

Power supply 128 is connected to MSU 112 via communication line 127. Preferably, communication line 127 is a CAT 5 cable terminated with an RJ-45 connector on each end.

MSU 112 may additionally contain an attached keyboard 122, cursor control device 126, and video monitor 124 which allow a user local to MSU 112 to control computers 118, power supply 128, etc. Keyboard 122, cursor control device 126, and video monitor 124 may be utilized to configure MSU 112 locally. Keyboard 122, cursor control device 126, and video monitor 124 may be connected to MSU 112 via standard keyboard, cursor control device, and video monitor connectors, 129.

To connect to the remote networking environment for administration and access, a user initiates a remote management session at user workstation 100. The user first accesses client software located using workstation 100, which prompts the user for a user name and password. However, the system may utilize any combination of identification data to identify and/or authenticate a particular user. Utilizing the attached keyboard 102, cursor control device 106 or other peripheral device, the user enters the user name and password. Once the user name and password have been entered, user workstation 100 connects to Internet/LAN/WAN 110 via communication line 111. User workstation 100 may connect to Internet/LAN/WAN 110 in a variety of ways. For example, user workstation 100 may be connected to Internet/LAN/WAN 110 through an Ethernet connection. In this example, communication line 111 would be a CAT 5 cable. The connection to Internet/LAN/WAN 112 may also be accomplished through a wireless connection which precludes the need for communication line 111. For example, MSU 112 may utilize standard Wireless Fidelity (“Wi-Fi”) networking equipment to communicate with Internet/LAN/WAN 110.

Alternatively, user workstation 100 may connect to MSU 112 via a PSTN by utilizing a modem connection. In this alternative example, communication lines 111 and 113 would be CAT 3 cables.

The username and password are then routed through Internet/LAN/WAN 110 to MSU 112 via communication line 113. MSU 112 receives the username and password and authenticates the user located at user workstation 100. Once the user has been authenticated by MSU 112, an option menu circuit located in MSU 112 provides an option menu to the user at workstation 100 via monitor 104 listing all the devices accessible through MSU 112. Alternatively, MSU 112 may send data indicative of the available remote computers 118. In this case, computer 108, included as part of user workstation 100 generates the menu (e.g., within a web-browser). The option menu allows the user to view available remote computers 118 and to choose a select remote computer 118 to monitor or control. The user makes selections from this option menu utilizing keyboard 102, cursor control device 106, or some other peripheral device attached to user workstation 100.

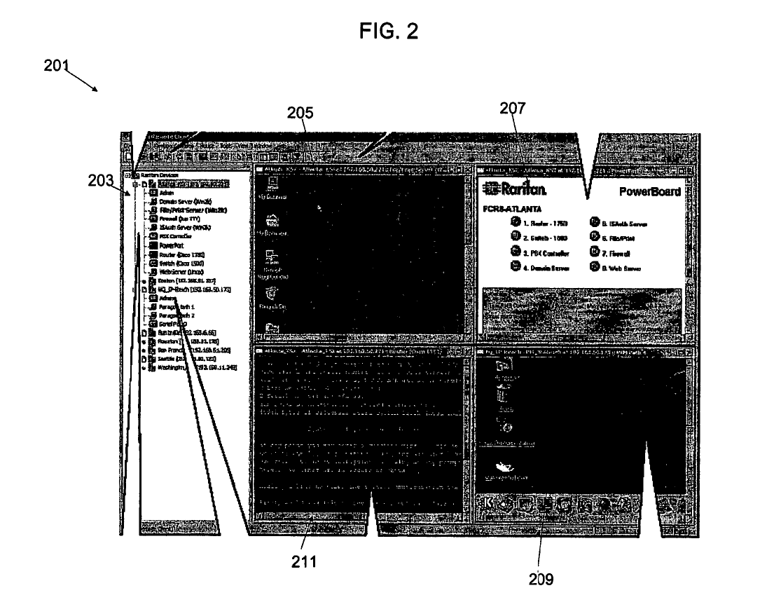

As shown in FIG. 2, option menu 201 consists of device list 203, first desktop window 205, power control window 207, second desktop window 209, and serial device window 211. Device list 203 lists all active and inactive devices connected to MSU 112. A user utilizes this menu to select the desired device for control. In this example, first desktop window 205 displays the desktop of one of the remote computers 118. By selecting first desktop window 205, a user may utilize keyboard 102, cursor control device 106, or some other peripheral device to control the displayed remote computer. In a similar manner, a user may utilize power control window 207 to access and operate power supply 128. Power control window 207 displays a list of all devices connected to power supply 128 as well as the status of each attached device such as average power utilized, RMS current, RMS voltage, internal temperature, etc. Power control window 207 is primarily utilized to cycle the power to the devices attached to power supply 128. However, since power supply 128 is programmable, power control window 207 may be utilized to perform any functions possible with power supply 128.

Second desktop window 209 is utilized to access and operate a second remote computer or server. Serial device window 211 is utilized to operate and access any remote serial device attached to MSU 112. Serial device window 211 displays the current output produced by the serial device as well as the previous output produced by the serial device. The previous output of the serial device is stored in a buffer located in MSU 112.

Preferably, option menu 201 consists of a menu in which the attached devices are arranged by their connection to MSU 112. The option menu also consists of a sub-menu for controlling power supply 128.

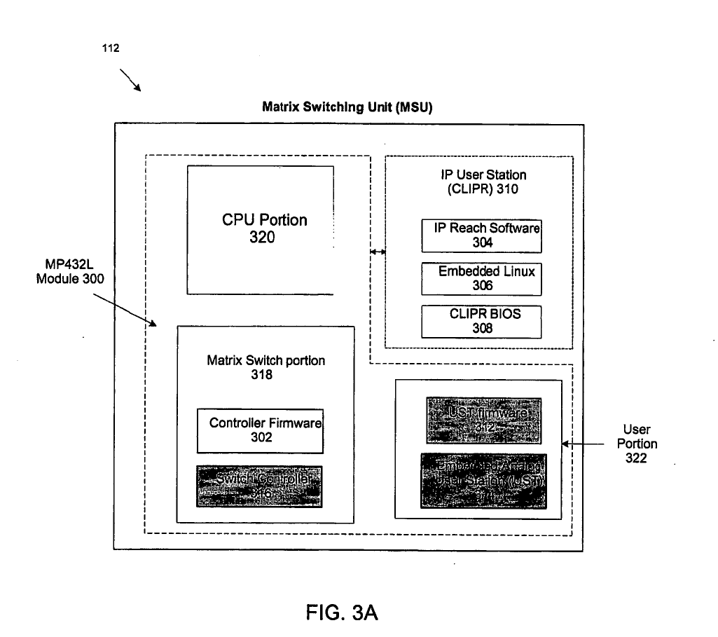

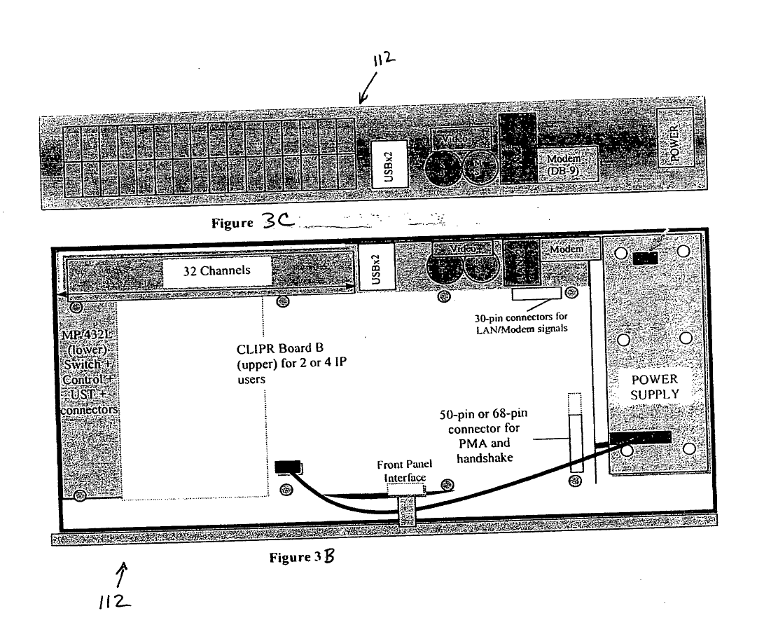

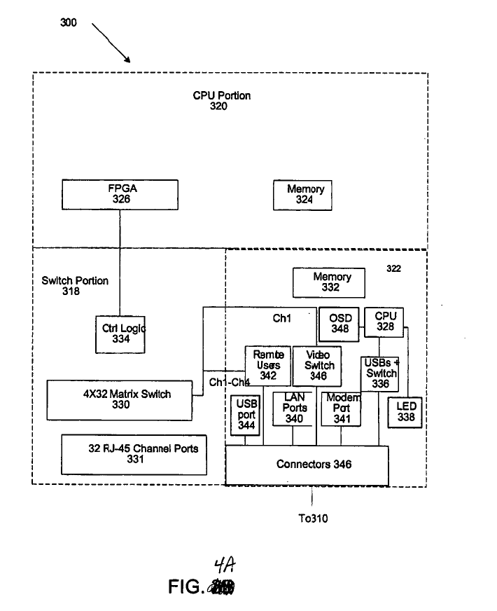

Next, FIG. 3A depicts a block diagram showing the major components of MSU 112, which enables both remote access from user workstations 100 and local administrator access from user workstation 120. The MSU hardware consists of the integration of a video compression module 310 with a switch and control module 300. FIG. 3B shows a schematic representation of a preferred embodiment of the internal layout of MSU 112. Switch and control module 300 comprises central processing unit (CPU) portion 320, matrix switch portion 318, and user portion 322. Matrix switch portion 318 includes a switch controller 316 which implements controller firmware 302. User portion 322, which primarily serves to provide local administrator access from user workstation 120, comprises embedded analog user station (UST) 314, which implements UST firmware 312. UST 314 operates to allow keyboard 122, video monitor 125 and cursor control device 126 to access MSU 112 and may include circuitry such as that disclosed in co-pending application Ser. No. 09/709,759, which is incorporated by reference herein in its entirety. In addition, FIG. 3C shows an example layout of the connectors on the back panel of MSU 112, showing the power, modem, LAN, USB, RJ45 and direct video, keyboard and mouse connectors.

Video compression module 310 is an IP user station embedded with up to four (4) channels. Video compression module 310 is hardware that preferably implements the compression algorithm of the present invention, which is disclosed in co-pending application Ser. No. 10/233,299, which is also incorporated herein by reference. Video compression module includes compression software 304 implemented using embedded Linux 306 and BIOS software 308.

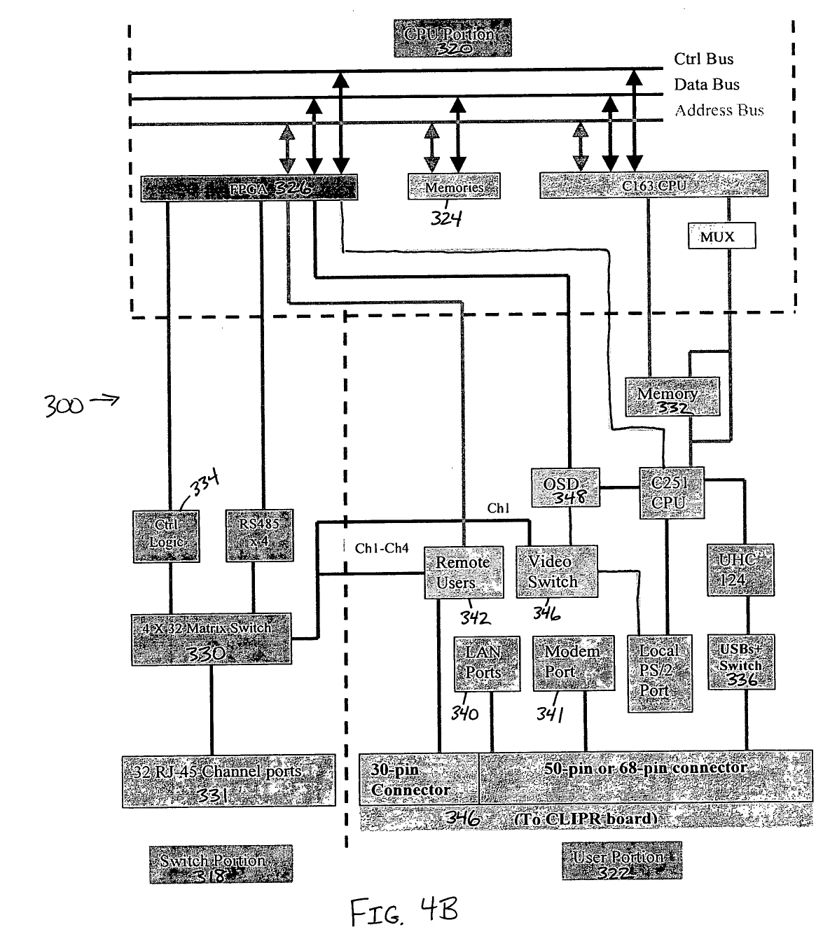

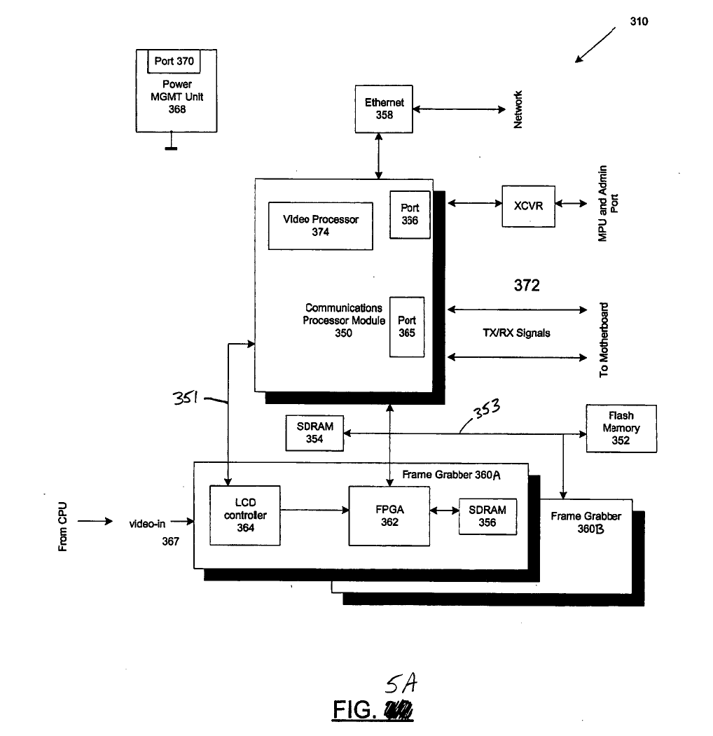

FIG. 4A depicts a detailed block diagram of the major components of switch and control module 300 of FIG. 3A. FIG. 4B shows a more detailed block diagram of the switching and control module 300 shown in FIG. 4A, further depicting the interconnection of the components of the switching and control module 300. Illustrated in FIGS. 4A & 4B are the hardware components that make up control/CPU portion 320, matrix switching portion 318 and user portion 322 of switch and control module 300. CPU portion 320 contains memory 324 which preferably include 512 KB FLASH for upgradeable program memory, 128 KB SRAM for packet buffers and 16 KB NVRAM for user/channel database. FPGA 326 provides UART interfaces for 4 users and 4 channels, LED control, and other glue logic (i.e., FPGA 326 provides control functionality for switch portion 318 and user portion 322.

Switch portion 318 includes matrix switch 330 which is the combination of eight sets of 1×16 switch cards for video and data switch and control logic 334 for video and switching data. Preferably, 16 or 32 RJ-45 channel ports 331 are supported. Switch 330 is capable of a “failsafe”firmware upgrade.

Finally, user portion 322 consists of RJ-45 and RJ-11 ports, Ethernet/LAN port 340 modem port 341, CPU 328 which handles one local analog PS/2 KVM port 350, two local USB V1.1 KB/MS inputs and OSD daughterboard 348. Memory 332 includes SRAM to store the firmware program of CPU 328 which is downloaded during system boot up. USB+switch 336 can alternate between CPU 328 for USB KB/MS, and video compression module 310 for USB CD-ROM/Flash devices. LAN ports 340 are used to connect a local area network of computers to video compression module 310. Similarly, modem port 341 allows for connection to a user supplied external modem for dial-in access. LED 338 is used to indicate power status, and to indicate the status of the Ethernet and user ports. User portion 322 further includes USB chip 344 to handle two USB ports for local keyboard and mouse input.

During operation, keyboard and cursor control device signals arrive from user workstations 100 to MSU 112 through network connections 109 and 113 (FIG. 1). As described above, these signals preferably arrive as TCP/IP data packets, and are thus received by one of LAN ports 340. Alternatively, if dial-up access is used, these signals arrive at modem port 341. The signals are supplied to video compression module 310 which contains hardware and software to interpret the TCP/IP data and to generate keyboard and cursor control device data which are supplied to the appropriate CIM 116 via matrix switch 330 and channel ports 331.

For local user workstation 120, keyboard and cursor control device signals arrive as data packets at either USB port 344 or pS/2 port 350, where they are supplied to CPU 328 such that an administrator may access and control MSU 112. Video switch 345 is used to switch video signals for the local user. Optionally, OSD 348 provides display for performing local user access and local administration. Alternatively, a general purpose CPU within MSU 112 may be used to display a more user-friendly interface to a user of local user workstation 120. Specifically, the CPU can be used to generate an administrator screen for basic local administration operation such as switching, configuring of IP addresses and other system information.

The system of the present invention contains two PMA ports to support two IP Reach users. However, PMA processing for four or more remote IP users is also contemplated. Connectors 346 include a 50-pin connector and a 30-pin connector for PMA interfaces, communication between switch and control module 300 and video compression 310 and signals from two Ethernet/LAN ports 340. An alternate embodiment may include a 68-pin connector or other type of connector.

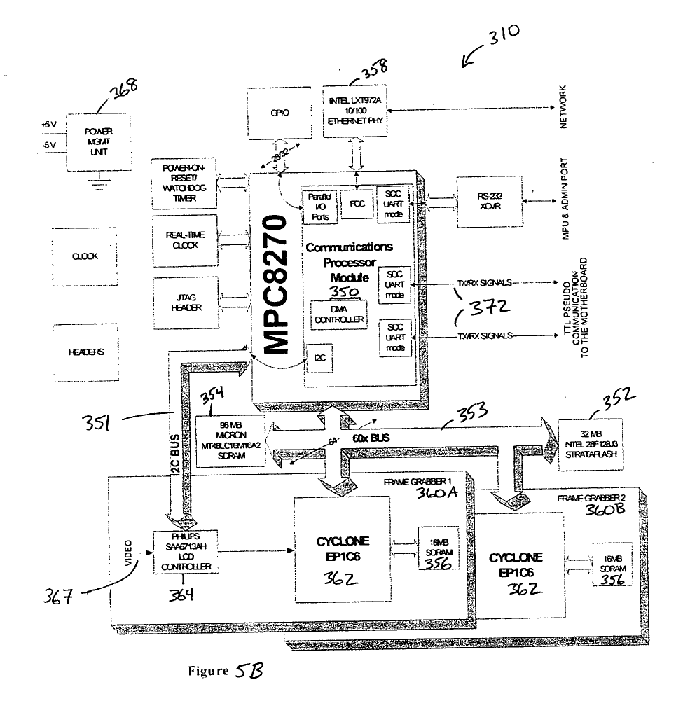

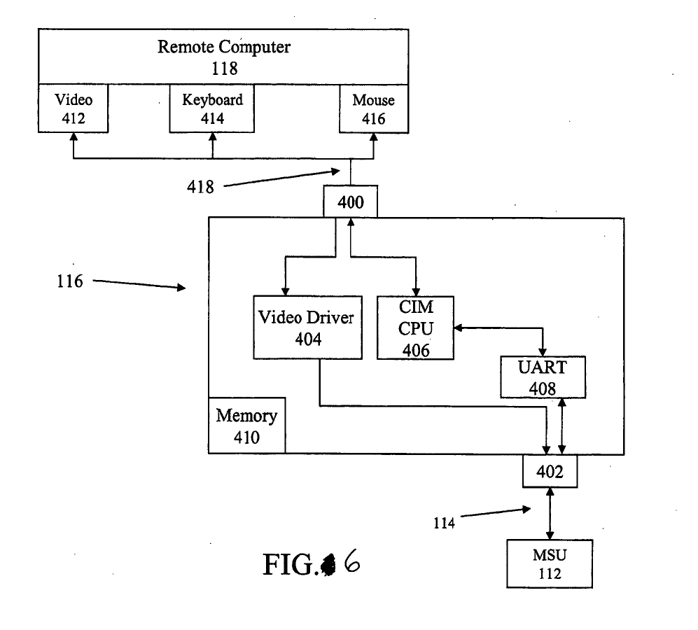

Turning next to FIGS. 5A & 5B, depicted are block diagrams of video compression module 310 shown in FIG. 3A. The video compression module may be designed as a single board to support four (4) IP reach users, or two (2) boards to support two (2) users on each board, and connecting these two boards with a cable. The hardware of video compression module 310 comprises communications processor module 350 which is a single chip computer system, flash memory 352, SDRAM 354 for frame buffers, packet buffers, etc., two Ethernet interfaces 358, and frame grabbers 360A & 360B for each digital user. Preferably, processor module 350 is connected to FPGAs 362 via a conventional 60× bus 353, and to LCD controller 364 via a conventional I2C bus 351. Frame grabbers 360A & 360B each have their own SDRAM 356 and FPGA 362 (which are only shown for frame grabber 360A in FIG. 5A). LCD controller chip 364 is used in every frame grabber 360A/B to support multiple video resolutions and fine tuning of video signals. Although only 2 frame grabbers 360A/B are shown, additional frame grabbers may be used. As shown, two serial ports 365 and 366 interface with switch and control module 300 for transmitting and receiving signals and for connecting the administrative user workstation 120, respectively. Further, each remote IP user has a channel 372 to communicate with the motherboard. Furthermore, a modem port, such as a DB-9 port, may be incorporated to support external user communication access via dial-in.

Ethernet ports 358 are configured as one active port and one hot standby port with a single MAC address and IP address. Furthermore, Ethernet ports 358 may feature an LED to indicate network activity.

Frame grabbers 360A and 360B, which preferably comprise LCD controller 364 and FPGA 362, performs the video compression algorithm of the present invention. Specifically, LCD controller 364 is used to fine-tune the video and FGPA 362 performs data compression. LCD controller 364 and FPGA 362 preferably communicate with communications module 350 via bus 351 and bus 353, respectively. With assistance from FPGA 362, communications module 350 performs 128-bit SSL encryption, packets data in IP and communicates with the remote user. After compression of the video signals is complete, the resulting video signals are transmitted over TCP/IP through Ethernet interface 358.

Video compression module 310 further performs administrative operation over the network using a web-based GUI, such as configuring of IP address and other system information. The hardware also performs functions such as management functions, downloads and upgrades, user authentication and authorization.

MSU 112 also contains a power supply 368 which supplies power to MSU 112. Preferably, power supply 368 is a redundant power supply which contains backup circuitry in case the main circuitry fails. Power supply 368 receives power through power port 370 from an external power supply. The power to MSU 112 is controlled by reset circuitry used to turn the power on or off and to reset MSU 112.

Turning next to FIG. 6, shown is a schematic diagram of CIM 116. CIM 116 may be compatible with any present day computer system, including but not limited to those manufactured by Microsoft (Windows), Apple (Macintosh), Sun (Unix), DEC, Compaq (Alpha), IBM (RS/6000), HP (HP9000) and SGI. However, it is foreseeable that the technology of the present invention will also be compatible with those computer systems not yet contemplated.

CIM 116 interfaces video port 412, keyboard port 414 and cursor control device port 416 of remote computer 118 to MSU 112 via CAT-5 cable 418 and port 400. CIM 116 transmits video signals uni-directionally from remote computer 118 to MSU 112. However, as discussed previously, keyboard and cursor control device signals may be transmitted bi-directionally between remote computer 118 and MSU 112.

During operation, video signals are transmitted from video port 412 of remote computer 118 to port 400 of CIM 116 via cable 419. From port 400, the unidirectional video signals are transmitted to video driver 404, which converts the standard red, green and blue video signals to a differential signal for transmission through port 402 to MSU 112 via cable 114. Each color signal is transmitted via its own twisted pair of wires contained within cable 114 (when transmitted from CIM 116 to MSU 112) or cable 110 (when transmitted from MSU 112 to UST 108) (FIG. 1). Furthermore, video driver 404 appends the horizontal and vertical synchronization signals to one of the red, green or blue video signals to allow all five components of the video signals to be transmitted via only three twisted pair of wires of cables 110 or 114. That is, the horizontal and vertical synchronization signals are each transmitted on its own color signal—not the same color signal.

In contrast, keyboard and cursor control device signals generated at remote computer 118 are received by CIM CPU 406 from keyboard port 414 and cursor control device port 416, respectively, via communication link 418 and port 400. Data packets representing the keyboard and cursor control device information in the received signals are generated by CIM CPU 406. The newly generated data packets are transmitted to UART 408, which serializes the signals and transmits them via communication link 114 to MSU 112 through port 402.

Conversely, keyboard and cursor control device signals received from the local user workstation through MSU 112 and cable 114 (FIG. 1) are received at port 402. Alternatively, the received data packet signals may be de-serializes by a non-UART device. CIM CPU 406 uses the information contained in the data packet signals to emulate keyboard and mouse signals. These emulated signals are applied to keyboard port 414 and mouse port 416 through port 400 via cable 418.

Furthermore, CIM 116 contains memory unit 410, which stores identification information for CIM 116 and its connected remote computer 118 including their assigned name, group, address, etc. Thus, if a specific remote computer 118 is not functioning properly, it is easy to assess which remote computer 118 has malfunctioned.

An example of the operation of the system of the present invention is now described. To utilize the system of the present invention, a user first initiates a remote management session at any one of user workstations 100a-n and enters the required user name and password. However, any unique combination of authentication may be utilized. User workstation 100 packetizes the entered information and routes it to Internet/LAN/WAN 110 via communication line 111 and then to MSU 112 via communication line 113 via an RJ-45 connector (i.e., Ethernet/LAN connector 340). Ethernet/LAN connector 340 interprets the TCP/IP data and transmits the received keyboard and/or cursor control device signals to CPU portion 320 of MSU 112. CPU portion 320 utilizes a lookup table containing all user profiles stored in the system to authenticate the user. Different user profiles may be given different levels of access to the system. For example, certain users may only be able to access and operate certain computers.

Once a user has been authenticated, an option menu, illustrated in screenshot 201 containing all the devices attached to MSU 112 is displayed. In this case, the devices include power supply 128, and CIMs 116 attached to remote computers 118. However, it would be apparent to one skilled in the art that MSU 112 may accommodate any number of CIMs, computers, serial devices, servers, etc, and associated power supplies. The option menu is generated by computer 108 using TCIP/IP data sent from MSU 112. As described, each user workstation 100 preferably includes a computer 108 so that the option menu can be accessed in a web-browser or applet. Specifically, TCP/IP data from MSU is transmitted through the network connection and interpreted using standard software on computer 108. The user then utilizes keyboard 102 and cursor control device 106 to select the desired device from the option menu. The user-entered keyboard and cursor control device signals are then encoded by user workstation 100, transmitted to MSU 112 via Internet/LAN/WAN 110, and subsequently decoded by MSU 112. MSU 112 interprets the received keyboard and cursor control device signals and interfaces the user with the selected device as previously described.

If the user selects to be interfaced with one of remote computers 118, video signals from the selected remote computer 118 are sent through CIM 116 to MSU 112 where video compression module 310 digitizes, tunes, and compresses the video signals. Specifically, the video signal initially arrives from the selected device at CIM 116 and is routed through matrix switch 330 to video switch 345 and to frame grabber 360 in video compression module 310 which converts the analog video signal to a digital signal. The resulting digitized video signal is then compressed by hardware on frame grabber 360, and packetized for TCP/IP transmission at either Ethernet connector 340 or communications port connector 341 of connectors 346. The TCP/IP data is sent to computer 108 of user workstation 100 through the appropriate network connection. Computer 108 interprets the TCP/IP data to generate video for video monitor 104.

Conversely, keyboard and cursor control device signals are packetized as TCP/IP data by computer 108 and transmitted to MSU 112. MSU 112, using video compression module 310, depacketizes the TCP/IP data and supplies emulated keyboard and cursor control device data to CIM 116, which subsequently supplies the data to the keyboard and cursor control device ports of remote computer 118. Thus, the system of the present invention enables a user at user workstation 100 to control a select remote computer 118.

To switch to another connected device, the user presses a “hotkey” such as “printscreen” or “F1” on keyboard 102 attached to user workstation 100 (FIG. 1). This causes the option menu to allow the user to select a new computer or modify the power supply to one of the connected devices.

While the present invention has been described with reference to the preferred embodiments and several alternative embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention. It should be appreciated that the present invention is capable of being embodied in other forms without departing from its essential characteristics.

1. (canceled)

2. A remote management system for connecting a user workstation of the type including a keyboard, cursor control device and monitor to at least one of a plurality of remote devices for access and control from said workstation, said system comprising:
a user workstation of the type including a keyboard, cursor control device and monitor;
a remote management unit coupled to said at least one interface device, said interface device couple to at least one remote device;
a first communication medium for providing bi-directional communication between said remote management unit and said user workstation to communicate;
a second communication medium for providing bi-directional communication between said remote management unit and said at least one interface device; and
a third communication medium for providing bi-directional communication between said at least one interface device and said at least one remote device.

3. A system according to claim 2, wherein said user workstation is capable of controlling a power source of each said remote device through said remote management unit.

4. A system according to claim 2, wherein said remote management unit includes at least one redundant power supply.

5. A system according to claim 2, wherein said remote management unit includes at least one Ethernet connector.

6. A system according to claim 2, wherein said remote management unit includes an option menu circuit for displaying on said monitor access information for said remote devices.

7. A system according to claim 6, wherein said information includes identification of said remote devices.

8. A system according to claim 2, wherein said remote management unit includes at least one keyboard, video and/or mouse (KVM) port.

9. A system according to claim 8, wherein said remote management unit includes at least one local KVM port.

10. A system according to claim 2, wherein said remote management unit includes at least one circuit for selectively communicating with at least one port of said interface devices.

11. A system according to claim 2, wherein said second communication medium is CAT-5 cable.

12. A system according to claim 2, wherein said remote management unit includes at least one frame grabber circuit for digitizing video signals.

13. A system according to claim 12. wherein said frame grabber circuit provides image correction of said video signals.

14. A system according to claim 13, wherein said framer grabber circuit converts analog video signals to digital video signals.

15. A system according to claim 2, wherein said remote management unit includes at least one video processor circuit for compressing video signals.

16. A system according to claim 15, wherein said video processor circuit includes at least one video receiving circuit for receiving video signals from at least one CPU.

17. A system according to claim 15, wherein said video processor circuit includes at least one circuit for storing of red, green and blue video signal components.

18. A system according to claim 15, wherein said video processor circuit includes at least one buffer circuit for storing video frames.

19. A system according to claim 15, wherein said video processor circuit includes at least one microprocessor for control of said compressing video signals.

20. A system according to claim 19, wherein said video processor circuit includes at least one memory circuit for use by said microprocessor.

21. A system according to claim 15, wherein said video processor circuit includes at least one switch for outputting signals.

22. A system according to claim 2, wherein said remote management unit includes at least one modem module for demodulating signals received by a modem.

23. A system according to claim 2, wherein said remote management unit includes at least one circuit for packetizing or depacketizing signals.

24. An apparatus for coupling a user workstation of the type including a keyboard, cursor control device and monitor to one or more remote devices, said apparatus comprising:
a communication circuit for transmitting signals to and receiving signals from said user workstation via a communication medium;
a serial communication circuit for transmitting serial data signals to and receiving serial data signals from one or more of interface devices connected to said remote devices; and
a central processing circuit for controlling said transmission of said signals and said serial data signals between one or more of said communication circuits, and said serial communication circuit.

25. An apparatus according to claim 24, wherein said apparatus is capable of controlling a power source of each said remote device.

26. An apparatus according to claim 25, wherein said user workstation controls said power source through said apparatus.

27. A apparatus according to claim 24, wherein said apparatus includes at least one redundant power supply.

28. A apparatus according to claim 24, wherein said remote management unit includes at least one Ethernet connector.

29. A apparatus according to claim 24, wherein said apparatus includes an option menu circuit for displaying on said monitor information for said remote devices.

30. An apparatus according to claim 29, wherein said information includes identification of said remote devices.

31. A apparatus according to claim 24, wherein said remote management unit includes at least one keyboard, video and/or mouse (KVM) port.

32. A apparatus according to claim 31, wherein said remote management unit includes at least one local KVM port.

33. A apparatus according to claim 24, wherein said remote management unit includes at least one circuit for selectively communicating with at least one port of said interface devices.

34. A apparatus according to claim 24, wherein said second communication medium is CAT-5 cable.

35. A apparatus according to claim 24, wherein said remote management unit includes at least one frame grabber circuit for digitizing video signals.

36. A apparatus according to claim 35, wherein said frame grabber circuit provides image correction of said video signals.

37. An apparatus according to claim 35, wherein said framer grabber circuit converts analog video signals to digital video signals.

38. A apparatus according to claim 24, wherein said remote management unit includes at least one video processor circuit for compressing video signals.

39. An apparatus according to claim 38, wherein said video processor circuit includes at least one circuit to receive video signals from said central processing circuit.

40. An apparatus according to claim 38, wherein said video processor circuit includes at least one circuit for storing red, green and blue video signal components.

41. An apparatus according to claim 38, wherein said video processor circuit includes at least one buffer circuit for storing video frames.

42. An apparatus according to claim 38, wherein said video processor circuit includes at least one memory circuit for use by a microprocessor for controlling said compressing video signals.

43. An apparatus according to claim 38, wherein said video processor circuit includes at least one switch for outputting signals to an Ethernet port or a modem port.

44. An apparatus according to claim 24, wherein said remote management unit includes at least one modem module for demodulating signals received by modem.

45. An apparatus according to claim 24, wherein said remote management unit includes at least one Ethernet connector for packetizing or depacketizing signals.

46. An apparatus according to claim 24, wherein said signals transmitted and received by said workstation are at least one control signal selected from the group consisting of keyboard, video, mouse, serial or power.

47. A method for managing remote devices from a workstation of the type including a keyboard, cursor control device and monitor over a network, said method comprising the steps of:
transmitting data signals to and from a user workstation via a communication medium;
transmitting serial data signals to and from one or more of said remote devices;
transmitting keyboard, video and mouse (KVM) signals to and from said one or more of said remote devices; and
remotely controlling said transmission of said data signals, said serial data signals and said KVM signals.

48. A method according to claim 47, wherein said remotely controlling is performed by a remote management device.

49. A method according to claim 48, wherein a said remote management device and said user work station are connected by said communication medium.

50. A method according to claim 48, wherein said one or more remote devices are connected to a power source.

51. A method according to claim 50, wherein said user workstation is capable of controlling said power source through said remote management device.

52. A method according to claim 48, wherein said remote management device includes at least one redundant power supply.

53. A method according to claim 48, wherein said remote management device includes at least one Ethernet connector.

54. A method according to claim 48, wherein said remote management device includes an option menu circuit for displaying on said monitor information for said remote devices.

55. A method according to claim 54, wherein said information includes identification said remote devices.

56. A method according to claim 48, wherein said remote management device includes at least one KVM port.

57. A method according to claim 48, wherein said remote management device includes at least one local KVM port.

58. A method according to claim 48, wherein said remote management device includes at least one circuit for selectively communicating with at least one port of said interface devices.

59. A method according to claim 48, wherein said remote management device includes at least one framer grabber circuit for digitizing video signals.

60. A method according to claim 59, wherein said frame grabber circuit provides image correction of said video signals.

61. A method according to claim 59, wherein said framer grabber circuit converts analog video signals to digital video signals.

62. A method according to claim 59, wherein said remote management device includes at least one video processor circuit for compressing video signals.

63. A method according to claim 62, wherein said video processor circuit includes at least one circuit to receive video signals from at least one CPU.

64. A method according to claim 62, wherein said video processor circuit includes at least one circuit for storing of red, green and blue video signal components.

65. A method according to claim 62, wherein said video processor circuit includes at least one buffer circuit for storing video frames.

66. A method according to claim 62, wherein said video processor circuit includes at least one microprocessor for controlling said compressing of video signals.

67. A method according to claim 66, wherein said video processor circuit includes at least one memory circuit for use by a microprocessor.

68. A method according to claim 62, wherein said video processor circuit includes at least one switch for outputting signals.

69. A method according to claim 48, wherein said remote management device includes at least one modem module for demodulating signals received by a modem.

70. A method according to claim 48, wherein said remote management device includes at least one Ethernet connector for packetizing or depacketizing signals.
